(19) United States
(12) Patent Application Publication
(10) Pub. No.: US 2021/0046474 A1
(43) Pub. Date: Feb. 18, 2021

(54) CARBON NANOTUBE YARN ELECTROOSMOTIC PUMP

(71) Applicant: Lintec of America, Inc., Richardson, TX (US)

(72) Inventor: Marcio Dias LIMA, Richardson, TX (US)

(73) Assignee: Lintec of America, Inc., Richardson, TX (US)

(21) Appl. No.: 16/982,288

(22) PCT Filed: Mar. 21, 2019
(86) PCT No.: PCT/US2019/023426

§ 371 Date: Sep. 18, 2020

Related U.S. Application Data
(60) Provisional application No. 62/646,293, filed on Mar. 21, 2018.

(51) Int. Cl. B01L 3/00; F04B 19/00; D02G 3/16

(52) U.S. Cl. CPC B01L 3/50273; F04B 19/006; D10B 2101/122; B01L 2400/0418; D02G 3/16

(57) ABSTRACT

An electroosmotic pump includes: a first carbon nanotube (CNT) yarn tube: a second CNT yarn tube; and a median tube. The first CNT yarn tube is fastened to one end of the median tube in a first connection portion. The second CNT yarn tube is fastened to another end of the median tube in a second connection portion. The first and second connection portions are sealed such that, a fluid cannot leak out through the first and second connection portions. Further, at least a portion of the inner surface of the median tube has a surface charge.

### CROSS REFERENCE TO RELATED APPLICATIONS

This application claims priority, pursuant to 35 U.S.C. § 119(e) to U.S. Provisional Application No. 62/646,293 entitled, “CARBON NANOTUBE YARN ELECTROOSMOTIC PUMP,” filed on Mar. 21, 2018. The contents of which are hereby incorporated by reference in its entirety.

### BACKGROUND

Artificial muscle devices based on elastic polymeric fibers have a wide range of applications. Artificial muscle devices comprising twisted and/or coiled polymers have the advantage of low cost, high production volume, and design simplicity. Artificial muscle devices may have advantages over small motors because of the greatly simplified engineering and lower product costs.

### SUMMARY

In one aspect, embodiments disclosed herein are directed to an electroosmotic pump that includes: a first carbon nanotube (CNT) yarn tube; a second CNT yarn tube; and a median tube. The first CNT yarn tube is fastened to one end of the median tube in a first connection portion. The second CNT yarn tube is fastened to another end of the median tube in a second connection portion. The first and second connection portions are sealed in such a way that prevents fluid from leaking out through the first and second connection portions. Further, at least a portion of the inner surface of the median tube has a surface charge.

In another aspect, embodiments of the invention are directed to a method of manufacturing an electroosmotic pump. The method includes: applying an adhesive on both ends of an inner surface of a median tube such that at least a portion of the inner surface of the median tube has a surface charge; fastening a first end of a first carbon nanotube (CNT) yarn tube to one end of the median tube to form a first connection portion; fastening a first end of a second CNT yarn tube to the other end of the median tube to form a second connection portion such that the first and second connection portions are sealed in a way that prevents fluid from leaking out through the first and second connection portions; disposing a first electrical connection to the first CNT yarn tube; and disposing a second electrical connection to the second CNT yarn tube.

Other aspects and advantages of one or more embodiments will be apparent from the following description and the appended claims.

### BRIEF DESCRIPTION OF DRAWINGS

FIG. 1 shows a carbon nanotube (CNT) yarn tube in accordance with one or more embodiments of the invention.

FIG. 2 shows an electroosmotic pump in accordance with one or more embodiments of the invention.

FIG. 3 shows a median tube for an electroosmotic pump in accordance with one or more embodiments of the invention.

FIG. 4 shows electroosmotic pumps in accordance with one or more embodiments of the invention.

FIG. 5 shows a method of manufacturing an electroosmotic pump in accordance with one or more embodiments of the invention.

### DETAILED DESCRIPTION

In the following detailed description of embodiments of the disclosure, numerous specific details are set forth in order to provide a more thorough understanding of the invention. However, it will be apparent to one of ordinary skill in the art that the disclosure may be practiced without these specific details. In other instances, well-known features have not been described in detail to avoid unnecessarily complicating the description.

In general, embodiments of the invention relate to a device that pumps a fluid and methods for manufacturing a device that pumps a fluid. The device may be an electroosmotic pump and may include two hollow carbon nanotube (CNT) yarn tubes (hereinafter, will be referred to as “CNT yarn tubes”) and a median tube that connects the two CNT yarn tubes. The electrical forces inside the electroosmotic pump move the fluid that is inside the electroosmotic pump,

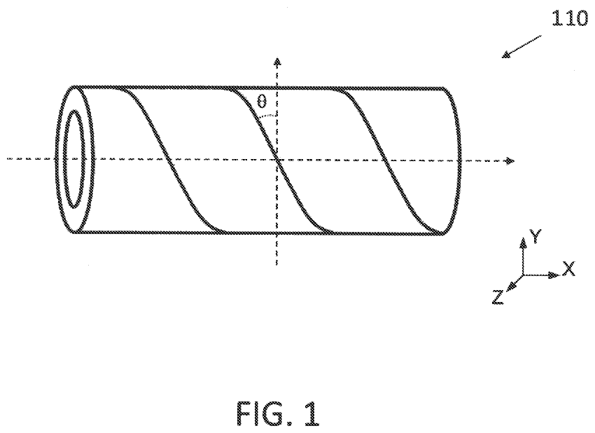

FIG. 1 shows a CNT yarn tube (110) that comprises one or more CNT sheets wrapped in form of a tube. Each of the CNT sheets is a thin sheet of a plurality of CNTs disposed next to each other and may be 0.2 millimeters (mm) wide or more. The CNT sheets may be wrapped to create a bias angle “θ” with a radial axis of the CNT yarn tube (110) that is perpendicular to the length of the CNT yarn tube (110). For example, in FIG. 1, the length of the CNT yarn tube (110) may be along the “X” axis and the radial axis may be along the “Y” axis. Accordingly, a bias angle close to 0 degree corresponds to the CNT sheets oriented almost parallel to the radial axis, and a bias angle close to 90 degrees corresponds to the CNT sheets oriented almost perpendicular to the radial axis.

In one or more embodiments, the CNT sheets may be braided such that the bias angles of the CNT sheets may cancel each other and the net bias angle of the CNT sheets may be 0 degrees (i.e., no bias angle).

In one or more embodiments, the CNT sheets may be wrapped to have a uniform bias angle across the length of the CNT yarn tube (e.g., along the “X” axis in FIG. 1) in a portion of the CNT yarn tube or the entire CNT yarn tube. Alternatively, in other embodiments, the bias angle may vary across the length of the CNT yarn tube.

In one or more embodiments, the CNT yarn tube may include a guest material infiltrating the CNT sheets. The guest material may infiltrate a portion or the entirety of the CNT sheets. The guest material may be selected based on, but not limited to, the ability of the guest material to infiltrate the CNT sheets and cover cavities in the CNT yarn tube, biocompatibility, melting point, or durability in hot and cold conditions. The guest material may be a silicone-based rubber, Silicone-based rubber may withstand high temperatures and may not squeeze out of the CNT yarn tube when heated. For example, the guest material may be Sylgard 184 silicone-based rubber or paraffin wax.

In one or more embodiments, the guest material may include: elastomers (e.g., silicone-based rubber, polyurethane, styrene-butadiene copolymer, and natural rubber); fluorinated plastics (e.g., perfluoroalkoxy alkane (PFA), polytetrafluoroethylene (PTFE), and fluorinated ethylene propylene (FEP)); aramids (e.g., Kevlar and nomex); epoxies; polyimides; or paraffin wax.

In one or more embodiments, walls of the CNT yarn tube are sealed such that fluid inside the CNT yarn tube does not leak or escape from the walls of the CNT yarn tube, as described in more detail below,

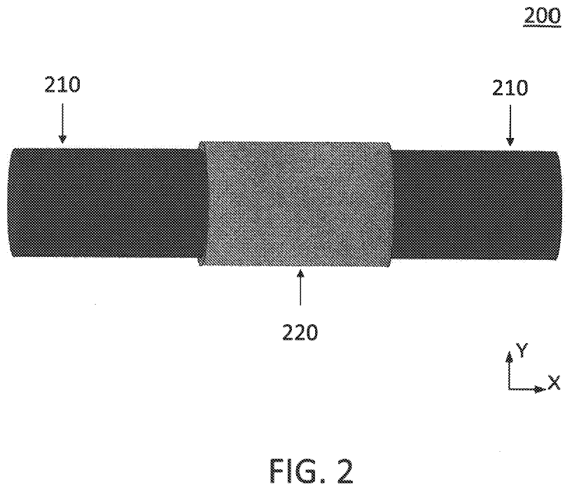

FIG. 2 shows an electroosmotic pump (200) in accordance with embodiments disclosed herein. The electroosmotic pump (200) includes two CNT yarn tubes (210) (i.e., first and second CNT yarn tubes). One end of each of the CNT yarn tubes (210) is connected or fastened to a median tube (220) such that the connection portions (i.e., fastening areas between the median tube (220) and each of the CNT yarn tubes (210)) are sealed and the fluid inside the electroosmotic pump (200) cannot escape from the connection portions i.e., the first and second connection portions).

In one or more embodiments, the CNT yarn tubes (210) may be connected fastened) to the median tube (220) via an adhesive. In these embodiments, the adhesive may be disposed between the median tube (220) and the CNT yarn tubes (210) in the connections portions. The adhesive may infiltrate outside portions of the CNT yarn tubes (210). For example, in a cross-sectional view in a direction along the X axis in FIG. 1, the adhesive may infiltrate the portions of the CNT yarn tube (110) toward the outside surface of the CNT yarn tube (110).

To seal the connection portions in a way that prevents fluid from escaping or leaking, an adhesive, the adhesive may be disposed on an inner surface of each end of the median tube (220). The connecting end of each of the CNT yarn tubes (210) may fit (i.e., inserted) inside the end of the median tube (220). Then, the adhesive becomes solid and seals the connection portions when the adhesive dries. For example, the adhesive may be a type of hot-melt glue. Alternatively, the adhesive may be applied to outer surfaces of the connecting ends of the CNT yarn tubes (210) before fitting the connecting ends of the CNT yarn tubes (210) inside the ends of the median tube (220).

In one or more embodiments, at least a portion of the CNT sheets that contacts the adhesive in the outer layers of the connecting end of each of the CNT yarn tubes (210) may not be infiltrated by the guest material or may not be densified. In such embodiments, the adhesive may infiltrate that portion to provide a strong adhesion.

In one or more embodiments, an inner portion of the connecting end of each of the CNT yarn tubes (110) may be treated with a fluoropolymer to block the adhesive from infiltrating into the inner portion of the connecting end. The fluoropolymer may include, but not limited to, any combination of materials from a group consisting of: polytetrafluoroethylene (PTFE), perfluoroalkoxy alkane (PFA), fluorinated ethylene propylene (FEP), ethylene tetra fluoroethylene (ETFE), polyvinylidene fluoride (PVDF), and ethylene chlorotrifluoroethylene (ECTFE).

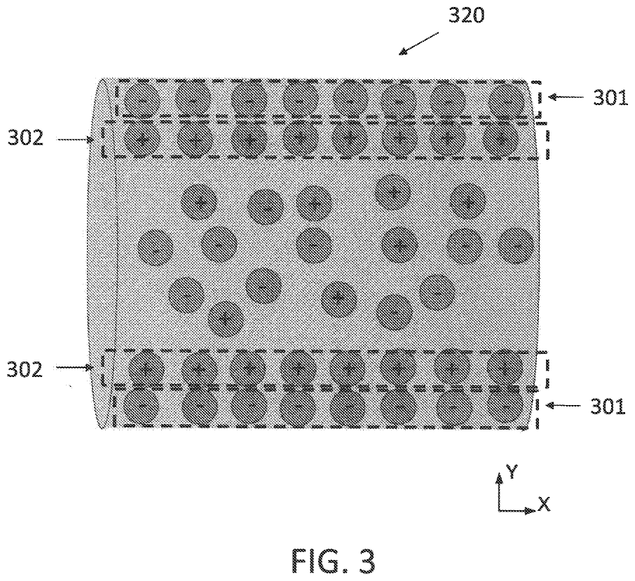

FIG. 3 demonstrates how the electroosmotic pump operates in accordance with one or more embodiments. The inner surface of the median tube (320) may have a negative surface charge. For example, at least a portion of the inner surface of the median tube (320) may be silicone or glass or may be comprised of some other hydrophobic coating. The negative charges (301) on the inner surface of the median tube (320) may be provided by the oxygen atoms on the glass portion of the inner surface of the median tube (320), The negative charges (301) on the inner surface of the median tube (320) attract positive charges (302) (e.g., positive ions) of a fluid, for example water. In these examples, the positive charges (302) of the hydrogen atoms in the water are attracted to the negative charges (301) of the inner surface of the median tube (320). As such, a double layer of opposite charges on the inner surface of the median tube (320) is formed. Accordingly, there exists a net charge of the fluid (e.g., negative net charge in this example) that can be electrically induced to flow inside the median tube (320).

In one or more embodiments, the entire inner surface of the median tube (320) is silicone or glass.

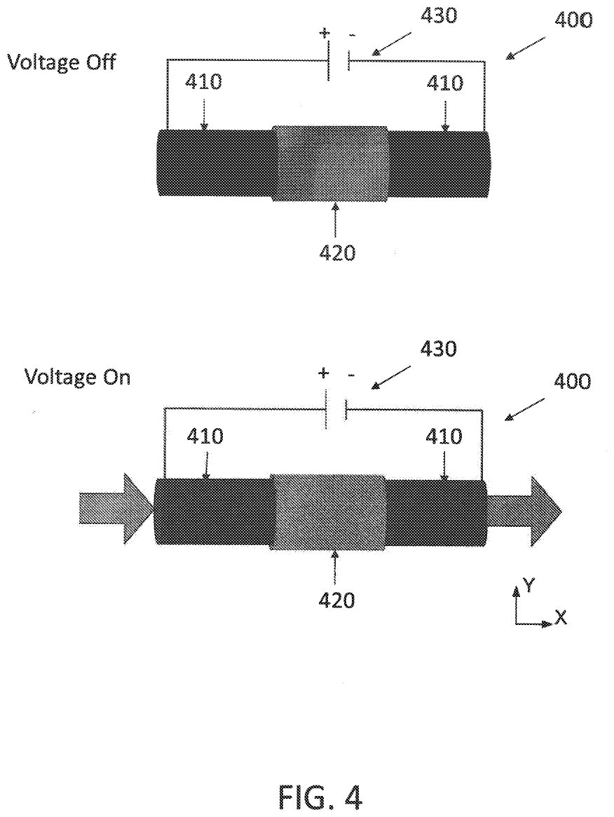

FIG. 4 shows an electroosmotic pump (400) and the operation of the electroosmotic pump (400) in accordance with embodiments disclosed herein. The electroosmotic pump (400) may include a power supply (430) that applies a potential difference (i.e., a bias voltage) between the two CNT yarn tubes (410) connected to the ends of the median tube (420). Because the fluid inside the median tube (420) has an overall net charge, upon applying a potential difference between the two CNT yarn tubes (410), the fluid is forced to flow through the CNT yarn tubes (410) and the median tube (420).

For example, as the result of the positive charges of water being attracted to the negative charges on the inner surface of the median tube (320) in the example described above with reference to FIG. 3, the resulting negative charges of water are forced to move by an applied potential difference. The applied potential difference determines the direction and force of the flow of the fluid in accordance with one or more embodiments disclosed herein. For example, the arrows in FIG. 4 demonstrate a flow of positively charged ions of the fluid (and therefore the flow of the fluid) inside the electroosmotic pump (400) upon the application of the potential difference.

In one or more embodiments, the CNT sheets of the CNT yarn tubes (410) are conductive and the power supply (430) may apply the potential difference to the CNT yarn tubes (410), as shown in FIG. 4. Alternatively, the power supply (430) may apply the potential difference directly to the median (420) by wiring the terminals of the power supply (430) to the ends of the median tube (420).

In one or more embodiments, by scaling down the inner diameters of the CNT yarn tubes, the pressure inside the CNT yarn tubes may be increased resulting in a decrease in the flow rate. One of ordinary skill in the art will appreciate that the diameters of the CNT yarn tubes, the diameter of the median tube, and the applied potential difference may be engineered for specific applications.

According to one or more embodiments, the electroosmotic pump may be a pump for a pneumatic actuator. In these embodiments, one of the CNT yarn tubes is closed-ended (e.g., the right-hand end of the right-hand side CNT yarn tube (410) in FIG. 4 may be closed) such that the fluid cannot flow through the closed end and thus, accumulates in the closed-ended CNT yarn tube. When the electroosmotic pump operates, the pressure of the fluid inside the closed-ended CNT yarn tube may increase and, thus, the diameter of the closed-ended CNT yarn tube increases, and the length of the closed-ended CNT yarn tube decreases. In these embodiments, the closed-ended CNT yarn tube may have no bias angle. Upon removing the potential difference, the closed-ended CNT yarn tube may return to an equilibrium state.

According to one or more embodiments, the closed-ended CNT yarn tube may have a net bias angle that allows torsional actuations of the closed-ended CNT yarn tube upon applying the potential difference. For example, θ in FIG. 1 being greater than 0 degree.

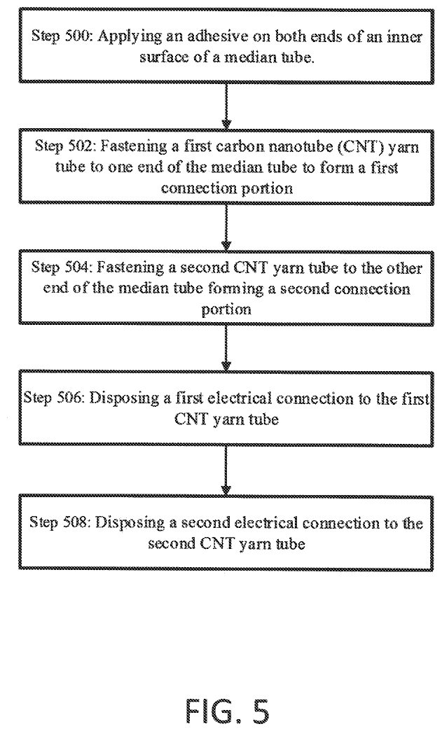

FIG. 5 is a flow chart demonstrating a method of manufacturing an electroosmotic pump in accordance with one or more embodiments disclosed herein. For example, an adhesive is applied to both ends of an inner surface of the median tube in Step 500. Then, in Step 502, an end (i.e., a first end) of the first CNT yarn tube is fastened to one end of the median tube to form a first connection portion. In Step 504, an end of (i.e., a first end) the second CNT yarn tube is fastened to the other end of the median tube forming a second connection portion. For example, the first ends of the first and second CNT yarn tubes may be fastened (i.e., connected) to the ends of the median tube via an adhesive that may be a type of hot-melt glue. Alternatively, the adhesive may be applied to outer surfaces of the first ends of the first and second CNT yarn tubes before fastening the first ends to the ends of the median tube. In Step 506, a first electrical connection is connected to the first CNT yarn tube and, in Step 508, a second electrical connection is connected to the second CNT yarn tube. The first and second electrical connections may be connected directly to the first and second CNT yarn tubes, or the connections may be made on the median tube in the first and second connection portions, respectively.

The first and second connection portions are sealed in a way that prevents fluid from leaking out through the device in accordance with one or more embodiments disclosed herein. Furthermore, as explained above, the median tube may include a surface charge.

In one or more embodiments, outer portions of the first and second CNT yarn tubes that adhere to the median tube may not be infiltrated with the guest material. As such, the adhesive may infiltrate the outer portions of the first and second CNT yarn tubes to improve adhesion. In these and other embodiments, the inner surface of the first and second CNT yarn tubes may be treated with a fluoropolymer prior to fastening the first and second CNT yarn tubes. As explained above, the fluoropolymer may prevent the adhesive from infiltrating into the inner portion of the first ends (i.e., connecting or fastening ends) of the first and second CNT yarn tubes.

In one or more embodiments, the first and second CNT yarn tubes, median tube, adhesive, and electrical connections to the first and second CNT yarn tubes may be similar to those in the embodiments above described with reference to FIGS. 1-4.

In the pneumatic actuator according to the embodiments described above, a second end of one of the first or second CNT yarn tubes may be sealed to form the actuator. As described above, in these embodiments, the first or second CNT yarn tube may include a bias angle to cause a rotation upon pumping the fluid into the actuator.

While the invention has been described with respect to a limited number of embodiments, those skilled in the art, having benefit of this disclosure, will appreciate that other embodiments can be devised without departing from the scope of the invention as disclosed herein.

1. An electroosmotic pump comprising:
a first carbon nanotube (CNT) yarn tube;
a second CNT yarn tube; and
a median tube,
wherein
the first CNT yarn tube is fastened to one end of the median tube in a first connection portion,
the second CNT yarn tube is fastened to another end of the median tube in a second connection portion,
the first and second connection portions are sealed in a way that prevents fluid from leaking out through the first and second connection portions, and
at least a portion of the inner surface of the median tube has a surface charge.

2. The electroosmotic pump according to claim 1, wherein the portion of the inner surface of the median tube is silicone and the fluid is water.

3. The electroosmotic pump according to claim 1, wherein the portion of the inner surface of the median tube is glass and the fluid is water.

4. The electroosmotic pump according to claim 1, further comprising a power supply that applies a potential difference between the first CNT yarn tube and the second CNT yarn tube,
wherein, by applying the potential difference, the power supply causes the fluid to flow inside the first CNT yarn tube, the median tube, and the second CNT yarn tube.

5. The electroosmotic pump according to claim 4, wherein the power supply is a DC power supply.

6. A pneumatic actuator that comprises the electroosmotic pump according to claim 4, wherein
the first CNT yarn tube has no bias angle,
one end of the first CNT yarn tube is closed, and
upon applying the potential difference between the first CNT yarn tube and the second CNT yarn tube, the power supply causes the fluid to accumulate in the closed first CNT yarn tube and the diameter of the first CNT yarn tube to increase.

7. A torsional actuator that comprises the electroosmotic pump according to claim 4, wherein
the first CNT yarn tube has a net bias angle more than 0 degree,
one end of the first CNT yarn tube is closed,
the closed first CNT yarn tube includes a bias angle, and
upon applying the potential difference between the first CNT yarn tube and the second CNT yarn tube, the power supply causes the fluid to accumulate in the closed first CNT yarn tube and the closed CNT yarn tube to rotate.

8. A method of manufacturing an electroosmotic pump, the method comprising:
applying an adhesive on both ends of an inner surface of a median tube, wherein at least a portion of the inner surface of the median tube has a surface charge;
fastening a first end of a first carbon nanotube (CNT) yarn tube to one end of the median tube to form a first connection portion;
fastening a first end of a second CNT yarn tube to the other end of the median tube to form a second connection portion;
sealing the first and second connection portions in a way that prevents fluid from leaking out through the first and second connection portions;
disposing a first electrical connection to the first CNT yarn tube; and
disposing a second electrical connection to the second CNT yarn tube.

9. The method of claim 8, further comprising:
infiltrating the first ends of the first and second CNT yarn tubes with a guest material such that the guest material does not infiltrate an outer portion of each of the first ends of the first and second CNT yarn tubes,
wherein the adhesive infiltrates the outer portions of the first ends of the first and second CNT yarn tubes.

10. The method of claim 8, further comprising:
treating an inner surface of each of the first ends of the first and second CNT yarn tubes with a fluoropolymer prior to fastening the first ends of the first and second CNT yarn tubes to the ends of the median tube.

11. The method according to claim 8, further comprising:
sealing a second end of the first CNT yarn tube,
wherein the first CNT yarn tube includes a bias angle.
